(19) United States
(12) Patent Application Publication
(10) Pub. No.: US 2023/0177536 A1
(43) Pub. Date: Jun. 8, 2023

(54) MANUFACTURING AND SALES PLANNING SUPPORT APPARATUS AND MANUFACTURING AND SALES PLANNING SUPPORT METHOD

(71) Applicant: HITACHI SOLUTIONS, LTD., Tokyo (JP)

(72) Inventors: Yumi KOBAYASHI, Tokyo (JP); Yasuhiro OZAWA, Tokyo (JP)

(21) Appl. No.: 17/960,170

(22) Filed: Oct. 5, 2022

(30) Foreign Application Priority Data
Dec. 3, 2021 (JP) 2021-196818

(51) Int. Cl. G06Q 30/02; G06Q 50/04; G06Q 30/00

(52) U.S. Cl. CPC G06Q 30/0202; G06Q 50/04; G06Q 30/018

(57) ABSTRACT

A manufacturing and sales planning support apparatus includes receiving a sales destination of a product whose manufacturing and sales involves greenhouse gas emission, a demanded quantity of the product at the sales destination, and processes for the manufacturing and sales of the product, and calculating, as output values, a maximum profit gained based on the processes with the greenhouse gas emission being at or below a predetermined upper limit and a volume of greenhouse gases emitted by the processes; creating a plurality of supply chain patterns each being information including a pattern of the processes for the manufacturing and sales of the product manufactured in a manufactured quantity corresponding to the sales destination of the product and the demanded quantity of the product at the sales destination; and inputting each of the supply chain patterns into the numerical model along with the sales destination and the manufactured quantity.

### CROSS-REFERENCE TO RELATED APPLICATION

This application claims priority pursuant to Japanese patent application No. 2021-196818, filed on Dec. 3, 2021, the entire disclosure of which is incorporated herein by reference.

### BACKGROUND

### Technical Field

The present invention relates to a manufacturing and sales planning support apparatus and a manufacturing and sales planning support method.

### Related Art

In the global supply chain today, it is important to meticulously design efficient product manufacturing and sales plans with circumstances of each country taken into consideration.

For example, Japanese Patent Application Publication No. 2021-152869 discloses a sales planning support apparatus that, aiming to check the feasibility of a sales plan, extracts a product associated with a scheduled time of sales and a person in charge of sales and the quantity of the product expected to be sold from sales schedule data, extracts a product, a sales figure, and the time of sales that are associated with the person in charge of sales from sales performance data, calculates an expected stock quantity of the extracted product by referring to the current stock data, ordering data, and manufacturing instruction data and using the extracted quantity of product expected to be sold, calculates an expected stock quantity of the extracted product in a next scheduled time of sales which comes after the above scheduled time of sales of the extracted product by referring to ordering data, manufacturing instruction data, and sales schedule data and using the calculated expected stock quantity, calculates an expected monetary amount of sales in the scheduled time of sales of the extracted product by referring to unit price data and using the extracted quantity expected to be sold, calculates an expected monetary amount of sales of the extracted product in the next scheduled time of sales by referring to the sales schedule data and the unit price data, and outputs results.

However, nowadays, it has been pointed out how business activities in such a supply chain greatly affect the environment. In particular, the influences of the greenhouse gas emissions produced by business activities have been pointed out. In order to achieve what is called sustainable development goals (SDGs), a system for realistically and efficiently reducing greenhouse gas emissions at the stage of product manufacturing and sales planning is necessary.

### SUMMARY

The present invention has been made in view of such backgrounds and aims to provide a manufacturing and sales planning support apparatus and a manufacturing and sales planning support method that can support manufacturing and sales planning that can comply with restrictions on the volume of greenhouse gas emissions.

An aspect of the present disclosure to solve the above objective is a manufacturing and sales planning support apparatus comprising: a processor; a memory; a numerical model storage part configured to store a numerical model that receives, as input values, a sales destination of a product whose manufacturing and sales involves greenhouse gas emission, a demanded quantity of the product at the sales destination, and processes for the manufacturing and sales of the product, and calculates, as output values, a maximum profit gained based on the processes with the greenhouse gas emission being at or below a predetermined upper limit and a volume of greenhouse gases emitted by the processes; a plan information acquisition part configured to acquire information related to the sales destination of the product and the demanded quantity of the product at the sales destination; a supply chain pattern creation part configured to create a plurality of supply chain patterns each being information including a pattern of the processes for the manufacturing and sales of the product manufactured in a manufactured quantity corresponding to the demanded quantity; and a simulation execution part configured to input each of the created supply chain patterns into the numerical model along with the acquired sales destination and the manufactured quantity and thereby calculate a maximum profit gained based on each of the supply chain patterns with the greenhouse gas emission being at or below the predetermined upper limit and a volume of greenhouse gases emitted by the processes.

Another aspect of the present disclosure to solve the above objective is a manufacturing and sales planning support method implemented by an information processing apparatus, comprising executing: numerical model storage processing to store a numerical model that receives, as input values, a sales destination of a product whose manufacturing and sales involves greenhouse gas emission, a demanded quantity of the product at the sales destination, and processes for the manufacturing and sales of the product, and calculates, as output values, a maximum profit gained based on the processes with the greenhouse gas emission being at or below a predetermined upper limit and a volume of greenhouse gases emitted by the processes; plan information acquisition processing to acquire information related to the sales destination of the product and the demanded quantity of the product at the sales destination; supply chain pattern creation processing to create a plurality of supply chain patterns each being information including a pattern of the processes for the manufacturing and sales of the product manufactured in a manufactured quantity corresponding to the demanded quantity; and simulation execution processing to input each of the created supply chain patterns into the numerical model along with the acquired sales destination and the manufactured quantity and thereby calculate a maximum profit gained based on each of the supply chain patterns with the greenhouse gas emission being at or below the predetermined upper limit and a volume of greenhouse gases emitted by the processes.

The present invention can support manufacturing and sales planning that can comply with restrictions on the volume of greenhouse gas emissions.

### BRIEF DESCRIPTION OF THE DRAWINGS

FIG. 1 is a diagram showing an example configuration of a manufacturing and sales planning support apparatus according to the present embodiment.

FIG. 2 is a diagram showing an example data format of a procurement master table.

FIG. 3 is a diagram showing an example data format of a manufacturing capacity master table.

FIG. 4 is a diagram showing an example data format of a BOM master table.

FIG. 5 is a diagram showing an example data format of a location cost master table.

FIG. 6 is a diagram showing an example data format of an inter-manufacturing-location transaction master table.

FIG. 7 is a diagram showing an example data format of a transportation master table.

FIG. 8 is a diagram showing an example data format of a customs duty master table.

FIG. 9 is a diagram showing an example data format of a foreign exchange master table.

FIG. 10 is a diagram showing an example data format of a sales plan master table.

FIG. 11 is a diagram showing an example data format of a greenhouse gas emission volume upper limit master table.

FIG. 12 is a diagram showing an example data format of a country-location master table.

FIG. 13 is a diagram illustrating an example hardware configuration of the manufacturing and sales planning support apparatus.

FIG. 14 is a flowchart illustrating an example of manufacturing and sales planning support processing.

FIG. 15 is a diagram showing an example of the manufacturing capacity master table registered.

FIG. 16 is a diagram showing an example of the sales plan master table registered.

FIG. 17 is a diagram showing an example of an input screen.

FIG. 18 is a diagram showing an example of a simulation execution screen.

FIG. 19 is a flowchart illustrating details of simulation execution processing.

FIG. 20 is a diagram illustrating an example of supply chain patterns.

FIG. 21 is a diagram illustrating an example configuration of a supply chain model.

FIG. 22 is a diagram showing an example of a simulation result DB.

### DETAILED DESCRIPTION

### <System Configuration>

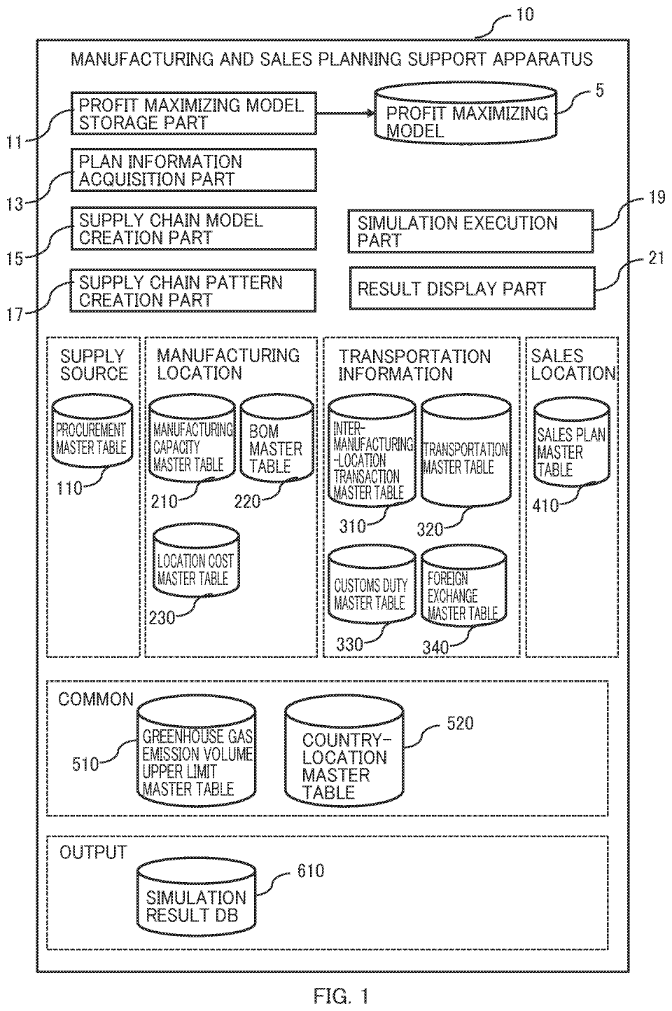

FIG. 1 is a diagram showing an example configuration of a manufacturing and sales planning support apparatus 10 according to the present embodiment. The manufacturing and sales planning support apparatus 10 supports manufacturing and sales planning of a product in a supply chain involving procurement of materials, manufacturing of the product using the materials, and sales of the product, and proposes to a user manufacturing and sales plans that allow a total volume of greenhouse gases produced by the manufacturing and sales of the product based on each process to be at or below a predetermined upper limit.

Specifically, the manufacturing and sales planning support apparatus 10 creates and stores a profit maximizing model 5 (to be described in detail later) which is a numerical model that receives input of information on, e.g., demands in a sales destination for a product to be manufactured (hereinafter called plan information) from a user and outputs information on a manufacturing and sales plan according to which the manufacturing and sales of the product emit greenhouse gases in a volume equal to or below a predetermined upper limit and also make as much profit as possible. Also, the manufacturing and sales planning support apparatus 10 stores databases (master tables) used to create the profit maximizing model 5.

Specifically, as information related to a supplier of a material for a product, the manufacturing and sales planning support apparatus 10 includes a procurement master table 110 that stores information on the location of the supplier of the material for the product, an item handled, and the like.

Also, as information related to a product manufacturing process, the manufacturing and sales planning support apparatus 10 includes a manufacturing capacity master table 210 that stores information on each manufacturing location's capacity of manufacturing a product (or a material (an intermediate product)), a BOM master table 220 that stores information on the composition of materials of each product, and a location cost master table 230 that stores information on the manufacturing costs at each manufacturing location.

Also, as information related to transportation of a material or product at locations (a supplier, a manufacturing location, a sales location), the manufacturing and sales planning support apparatus 10 includes an inter-manufacturing-location transaction master table 310 that stores information related to the transaction price of a product between manufacturing locations (an internal transaction price), a transportation master table 320 that stores information related to the costs of transportation of a material or product between manufacturing locations, a customs duty master table 330 that stores information on customs duties for import and export between countries which correspond to between locations, and a foreign exchange master table 340 that stores information related to foreign exchange rates between locations (countries).

The manufacturing and sales planning support apparatus 10 also includes a sales plan master table 410 that stores plan information.

The manufacturing and sales planning support apparatus 10 also includes a greenhouse gas emission volume upper limit master table 510 that stores information on a total volume of greenhouse gases permitted to be emitted in manufacturing and sales processes, the total volume being set for each country or region, and a country-location master table 520 that stores the correspondences between each country and locations therein.

The manufacturing and sales planning support apparatus 10 also includes a simulation result DB 610 that stores the results of execution of the profit maximizing model 5.

Next, the data format of each master table is described.

### (Procurement Master Table)

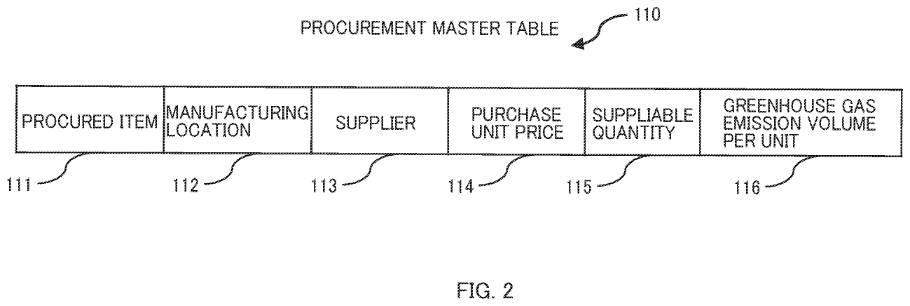

FIG. 2 is a diagram showing an example data format of the procurement master table 110. The procurement master table 110 has the following data items: procured item 111 to set information on an item as a material (an intermediate product) for a product, manufacturing location 112 to set information on a manufacturing location where the material is manufactured, supplier 113 to set information on a supplier (supply source) of the material, purchase unit price 114 to set the purchase unit price of the material, suppliable quantity 115 to set the quantity of the material that the supplier can supply, and greenhouse gas emission volume 116 to set the volume of greenhouse gas emissions produced by manufacturing a per-unit quantity of the material. Note that the profit maximizing model 5 calculates a total purchase monetary amount of the material based on the purchase unit price and the following data items in the BOM master table 220 to be described later: parent item, child item, and quantity of child item used.

Note that when a certain material (an intermediate product) or a product is manufactured, there are cases where the material or product can be manufactured using a plurality of material patterns.

### (Manufacturing Capacity Master Table)

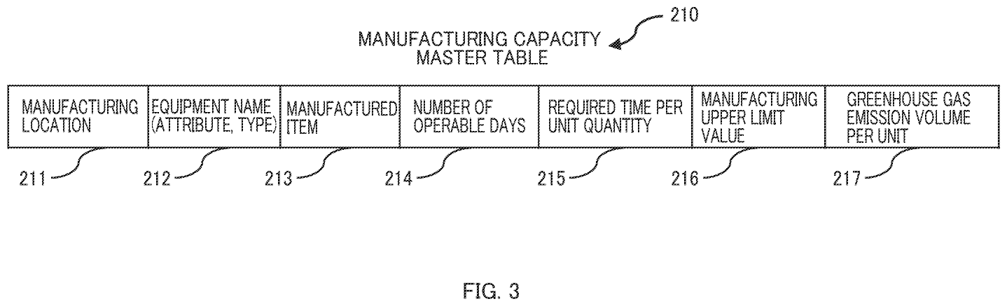

FIG. 3 is a diagram showing an example data format of the manufacturing capacity master table 210. The manufacturing capacity master table 210 has the following data items: manufacturing location 211 to set information on a location (such as a factory) where a product or a material (an intermediate here) is manufactured, equipment name 212 to set information on equipment for manufacturing the product or material, manufactured item 213 to set information on the item as the product or material, number of operable days 214 to set information on the number of days the equipment can operate, required time 215 to set a time required to manufacture a per-unit quantity of the product or material, manufacturing upper limit value 216 to set the upper limit value of the quantity of the product or material manufactured, and greenhouse gas emission volume 217 to set the volume of greenhouse gas emissions produced by manufacturing a per-unit quantity of the product or material.

Note that information set in the equipment name 212 includes not only the name of equipment, but also information on the type or attribute of the equipment (e.g., whether the equipment operates using renewable energy). Also, a plurality of types of equipment that can manufacture the same material or product may exist at the same manufacturing location. Also, equipment that can manufacture the same material or product may exist at a plurality of manufacturing locations.

### (BOM Master Table]

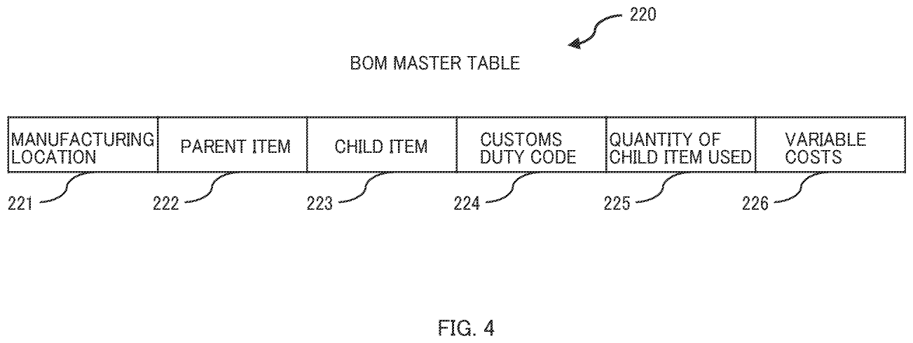

FIG. 4 is a diagram showing an example data format of the BOM master table 220. The BOM master table 220 has the following data items: manufacturing location 221 to set information on a location where a product or material (an intermediate product here) is manufactured, parent item 222 to set information on the item as the product or material (hereinafter referred to as a parent item), child item 223 to set information on the item as a material forming the product or material being the parent item (hereinafter referred to as a child item), customs duty code 224 to set the identification code (customs duty code) of the customs duties imposed on the import of the product or material being the parent item, quantity of child item used 225 to set the quantity of the material being the child item used, and variable costs 226 to set variable costs of manufacturing the product or material being the parent item. Note that the parent item 222, the child item 223, and the quantity of child item used 225 are used to identify the item and quantity of a material forming the product. Note that it is assumed in the present embodiment that in the same factory, a combination of materials forming each product is the same. Meanwhile, there are a plurality of possible suppliers for each material.

### (Location Cost Master Table)

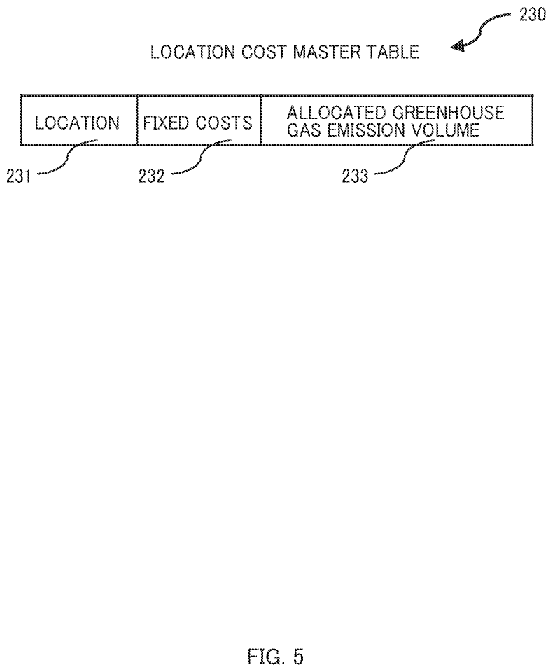

FIG. 5 is a diagram showing an example data format of the location cost master table 230. The location cost master table has the following data items: manufacturing location 231 to set information on a manufacturing location, fixed costs 232 to set information on fixed costs which are costs required to manage and maintain the manufacturing location, and allocated greenhouse gas emission volume 233. Note that information set in the allocated greenhouse gas emission volume 233 is an overall greenhouse gas emission volume managed at the manufacturing location (factory) as a total volume (hereinafter referred to as an allocated greenhouse gas emission volume). The profit maximizing model 5 can calculate a greenhouse gas emission volume per unit quantity (e.g., piece) of a product by combining a volume obtained by proportionally dividing the allocated greenhouse gas emission volume by a time required to manufacture a per-unit quantity of the product in relation to the total production time in the manufacturing location (factory), with the per-unit greenhouse gas emission volume indicated by the greenhouse gas emission volume 217 in the manufacturing capacity master table 210.

### (Inter-Manufacturing-Location Transaction Master Table)

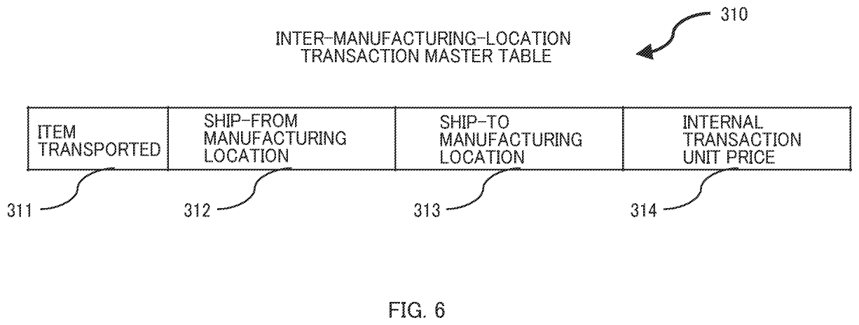

FIG. 6 is a diagram showing an example data format of the inter-manufacturing-location transaction master table 310. The inter-manufacturing-location transaction master table 310 has the following data items: item 311 to set information on the item as a product or material, ship-from location 312 to set information on a manufacturing location from which the product or material is shipped, ship-to location 313 to set information on a manufacturing location to which the product or material is shipped, and internal transaction unit price 314 to set the internal transaction unit price (to be described later) of the product or material. Note that the internal transaction unit price 314 is used by the profit maximizing model 5 to calculate the amount of custom duties to be described later.

### (Transportation Master Table)

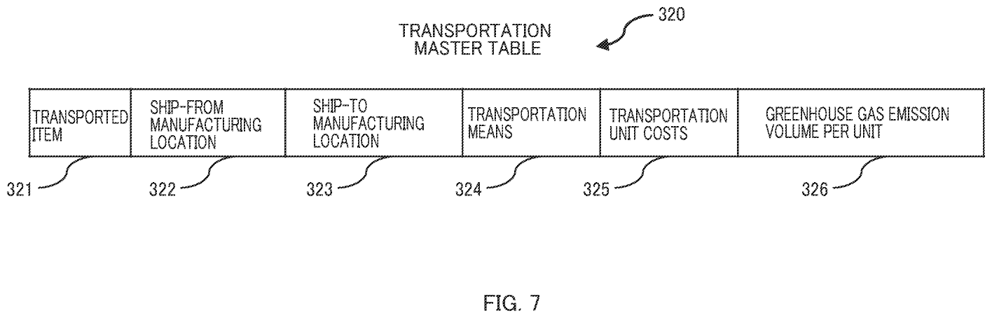

FIG. 7 is a diagram showing an example data format of the transportation master table 320. The transportation master table 320 has the following data items: item 321 to set information on the item as a product or material, ship-from location 322 to set information on a manufacturing location from which the product or material is shipped, ship-to location 323 to set information on a manufacturing location to which the product or material is shipped, transportation means 324 to set information on means of transportation of the product or material, transportation unit costs 325 to set the unit costs of transportation (the unit costs of transportation costs) of the product or material, and greenhouse gas emission volume 326 to set the volume of greenhouse gas emissions produced by manufacturing of a per-unit quantity of the product or material. Note that the profit maximizing model 5 calculates the transportation costs based on the transportation unit costs and the quantity of the material or product transported. Also, an emission volume set in the greenhouse gas emission volume 326 is different depending on the means of transportation. For example, a larger value is set if the means of transportation is an automobile, and a smaller value is set if the means of transportation is a train.

### (Customs Duty Master Table)

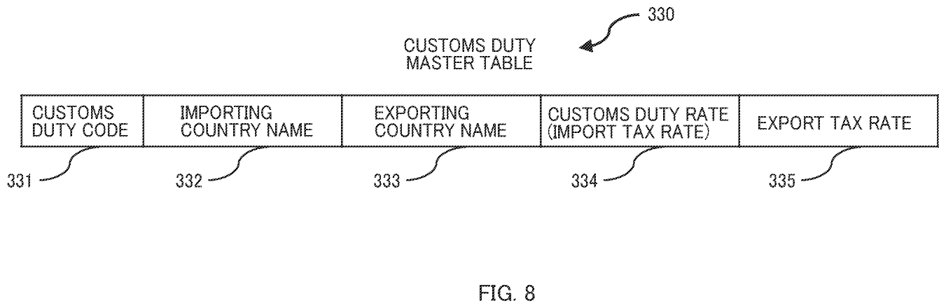

FIG. 8 is a diagram showing an example data format of the customs duty master table 330. The customs duty master table 330 has the following data items: customs duty code 331 to set a customs duty code for import and export of a product or material, importing country name 332 to set the name of an importing country involved in the import and export, exporting country name 333 to set the name of an exporting country involved in the import and export, customs duty rate 334 to set the rate of customs duties (import tax rate) related to the export and import, and export tax rate 335 to set the export tax rate for the custom duties related to the export and import.

### (Foreign Exchange Master Table)

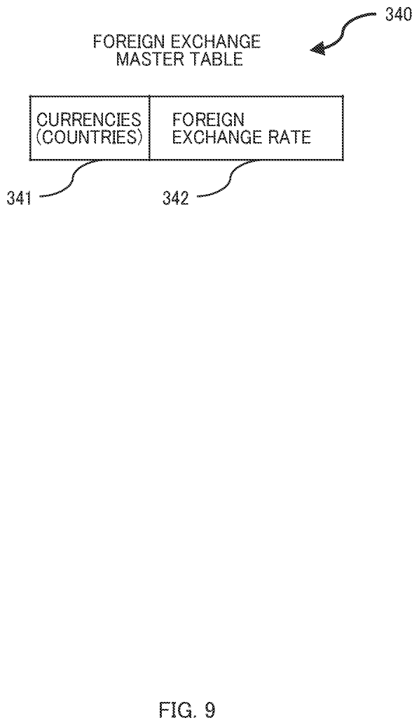

FIG. 9 is a diagram showing an example data format of the foreign exchange master table 340. The foreign exchange master table 340 has the following data items: currencies 341 to set information on currencies and foreign exchange rate 342 to set information on the rate of foreign exchange between the currencies.

### (Sales Plan Master Table)

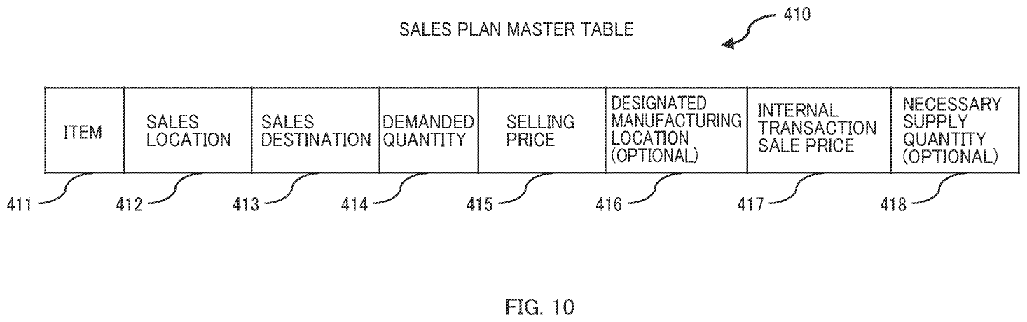

FIG. 10 is a diagram showing an example data format of the sales plan master table 410. The sales plan master table 410 has the following data items: item 411 to set information on the item as a product to be manufactured, sales location 412 to set information on a location where the product is sold, sales destination 413 to set information on a sales destination based on the sales location of the product, demanded quantity 414 to set a quantity of the product demanded at the sales destination, selling price 415 to set the selling price of the product, designated manufacturing location 416 to set information on a manufacturing location designated in advance for the product, internal transaction sale price 417 to set the price used as a basis for calculating the customs duties on the product (internal transaction sale price), and necessary supply quantity 418 to set a necessary (minimum) supply quantity (hereinafter referred to as a necessary supply quantity) of the product. Note that setting information in the designated manufacturing location 416 and the necessary supply quantity 418 is optional.

### (Greenhouse Gas Emission Volume Upper Limit Master Table)

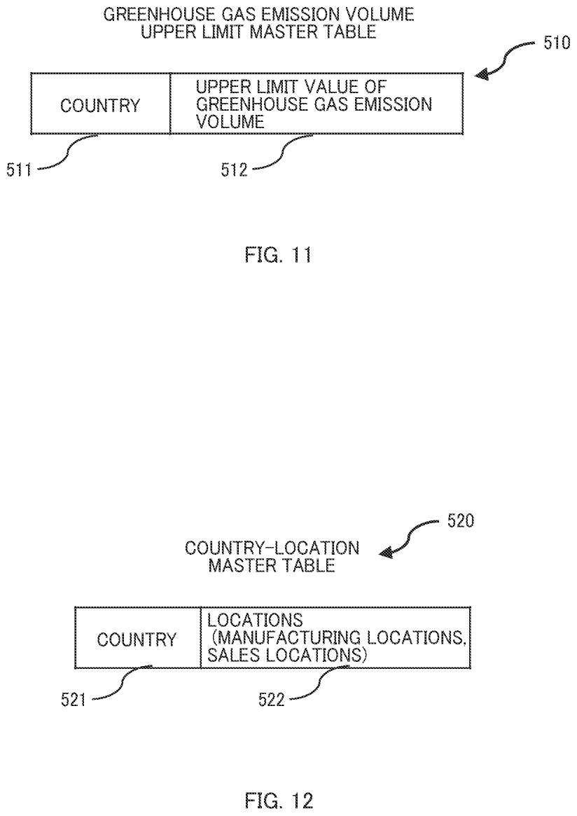

FIG. 11 is a diagram showing an example data format of the greenhouse gas emission volume upper limit master table 510. The greenhouse gas emission volume upper limit master table 510 has the following data items: country 511 to set the name of a country (or region) and upper limit value of greenhouse gas emission volume 512 to set the upper limit value of a greenhouse gas emission volume in the country (or region). Note that the upper limit of a greenhouse gas emission volume is, for example, an upper limit set by each business operator (such as a manufacturer, a seller, or a management provider).

### (Country-Location Master Table)

FIG. 12 is a diagram showing an example data format of the country-location master table 520. The country-location master table 520 has the following data items: country 521 to set the name of a country (or region) and locations 522 to set a list of suppliers, manufacturing locations, and sales locations in the country.

Next, as shown in FIG. 1, the manufacturing and sales planning support apparatus 10 includes the following functional parts (programs): a profit maximizing model storage part 11, a plan information acquisition part 13, a supply chain model creation part 15, a supply chain pattern creation part 17, a simulation execution part 19, and a result display part 21.

The profit maximizing model storage part 11 stores the profit maximizing model 5. The profit maximizing model 5 receives input of a sales destination of a product that involves, during its manufacturing and sales, emission of greenhouse gases and a quantity demanded at the sales destination (the sales plan master table 410) as well as processes for the manufacturing and sales of the product (the other master tables) and outputs the maximum profit gained by the above-described manufacturing and sales processes with greenhouse gas emissions being at or below a predetermined upper limit and the volume of greenhouse gases emitted by the above-described processes.

Based on user input, the plan information acquisition part 13 acquires information related to a sales destination of a product and the quantity of the product demanded at the sales destination (the plan information or the sales plan master table 410). Note that the plan information acquisition part 13 may acquire the plan information or the sales plan master table 410 not based on user input but automatically from another information processing apparatus.

The supply chain model creation part 15 creates a supply chain model which has nodes and links and is information on the relations between the nodes, the nodes being a supplier of a material, a manufacturing location for a product or an intermediate product, manufacturing equipment in the manufacturing location, and a sales location for the product, the links being information on connections (means of transportation) between the nodes. The profit maximizing model 5 is a model based on this supply chain model.

The supply chain pattern creation part 17 creates a plurality of supply chain patterns as information including patterns of processes related to manufacturing and sales of a product manufactured in a quantity corresponding to a demanded quantity.

The simulation execution part 19 inputs each supply chain pattern created by the supply chain pattern creation part 17 to the profit maximizing model 5 along with the sales destination acquired by the plan information acquisition part 13 and the above-described manufactured quantity, thereby calculating the maximum profit gained based on the supply chain pattern with greenhouse gas emissions being at or below the predetermined upper limit and also calculating the volume of greenhouse gas emissions.

The result display part 21 displays information on the maximum profit calculated by the profit maximizing model 5 and also displays information on the processes for manufacturing and sales of the product inputted into the profit maximizing model 5 (information identifying the master tables used).

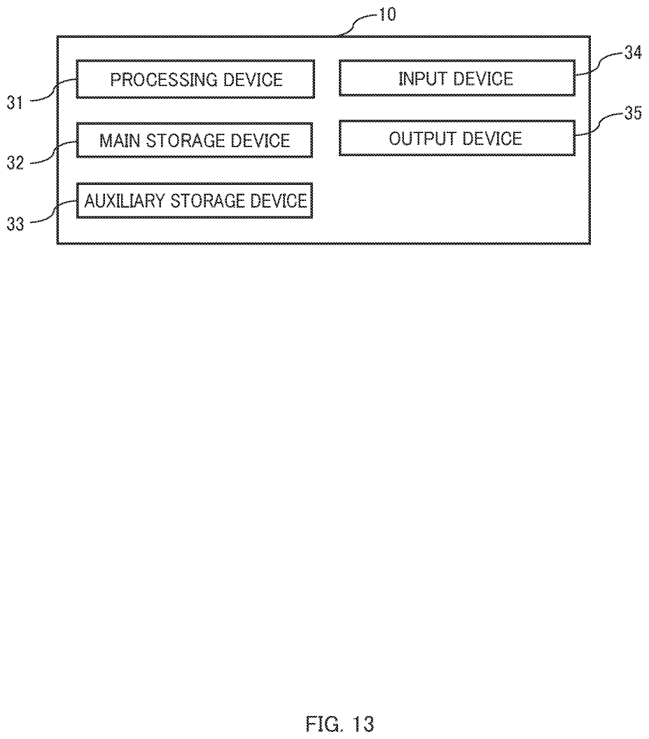

Next, FIG. 13 is a diagram illustrating an example hardware configuration of the manufacturing and sales planning support apparatus 10. The manufacturing and sales planning support apparatus 10 includes a processing device 31 (processor) such as a central processing unit (CPU), a main storage device 32 (memory) such as a random-access memory (RAM) or a read-only memory (ROM), an auxiliary storage device 33 such as a hard disk drive (HDD) or a solid-state drive (SSD), an input device 34 formed by a keyboard, a mouse, a touch panel, and/or the like and an output device 35 which is formed by a monitor (display) or the like and displays screens.

The functions of the manufacturing and sales planning support apparatus 10 may be implemented when the hardware of the manufacturing and sales planning support apparatus 10 or the processing device 31 of the manufacturing and sales planning support apparatus 10 reads and executes the programs stored in the main storage device 32 or the auxiliary storage device 33. Also, these programs are stored in, for example, a storage device such as a secondary storage device, a non-volatile semiconductor memory, a hard disk drive, or an SSD, or a recording medium readable by an information processing apparatus, such as an IC card, an SD card, or a DVD. Note that, like a virtual server provided by a cloud system, the manufacturing and sales planning support apparatus 10 may be partly or entirely implemented using, for example, virtual information processing resources provided using a virtualization technique, a process space separation technique, or the like. Also, all or some of the functions provided by each information processing apparatus may be implemented by, for example, a service provided by a cloud system via an application programming interface (API) or the like.

Next, processing performed by the manufacturing and sales planning support apparatus 10 is described.

### <Manufacturing and Sales Planning Support Processing>

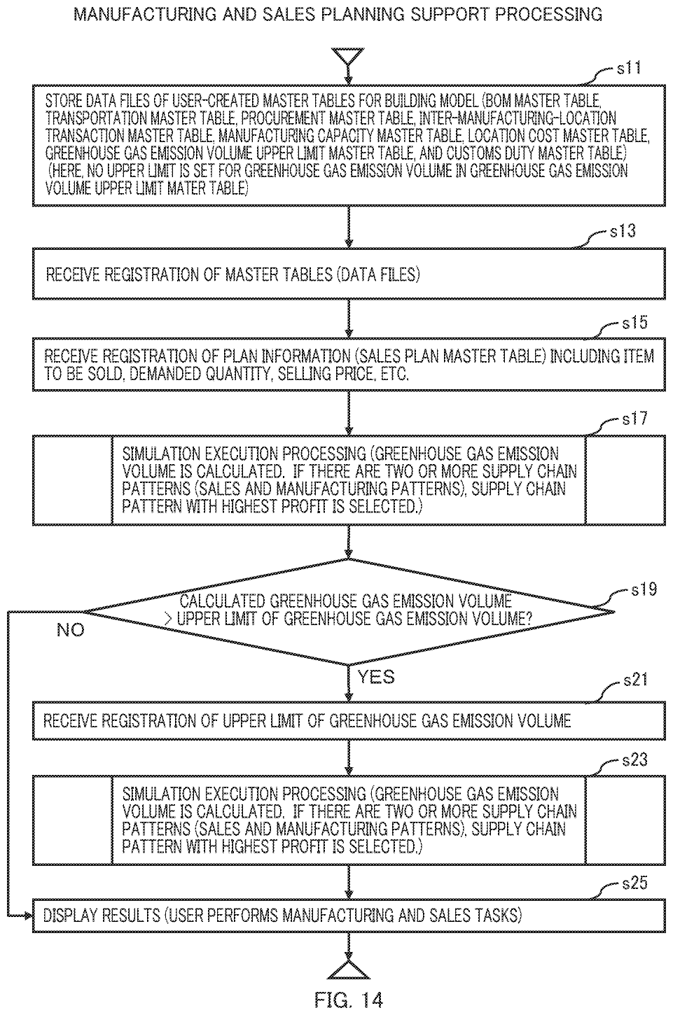

FIG. 14 is a flowchart illustrating an example of manufacturing and sales planning support processing for supporting product manufacturing and sales planning, which is a business task carried out by a user. The manufacturing and sales planning support processing is started when, for example, the manufacturing and sales planning support apparatus 10 receives a predetermined input from a user.

First, the simulation execution part 19 of the manufacturing and sales planning support apparatus 10 stores master tables necessary to build a supply chain model (s11).

For example, the simulation execution part 19 activates a predetermined editing application based on an activation instruction from a user. The editing application receives, from the user, input of data values for the procurement master table 110, the manufacturing capacity master table 210, the BOM master table 220, the location cost master table 230, the inter-manufacturing-location transaction master table 310, the transportation master table 320, the customs duty master table 330, and the greenhouse gas emission volume upper limit master table 510, and creates and stores data files of the master tables. Note that the foreign exchange master table 340 and the country-location master table 520 are also created as needed.

Note that it is assumed here that in order to check how much profit can be gained when there are no restrictions on the greenhouse gas emission volume, the user has set “no upper limit” (e.g., a sufficiently large value) as a data value for the upper limit value of greenhouse gas emission volume 512 in the greenhouse gas emission volume upper limit master table 510.

Then, the simulation execution part 19 receives user's selection of master tables created in s11 and registers the selected master tables (s13). For example, the simulation execution part 19 displays a predetermined input screen and receives, from the user, registration of data files of master tables to be used for execution of simulation.

The plan information acquisition part 13 also registers a sales plan (plan information) designed by the user (s15). For example, the plan information acquisition part 13 activates a predetermined editing application in response to an activation instruction from the user. The editing application receives user input of the following data values: the item as each product to be manufactured, a sales location for the product, a sales destination of the product, a demanded quantity of the product at the sales destination (i.e., an estimated manufactured quantity of the product), a selling price of the product, a designated manufacturing location for the product (optional), an internal transaction sale price of the product, and a necessary supply quantity of the product (optional). The editing application then creates and stores a data file of the sales plan master table 410 having the above inputted data values. Then, after the above editing application is ended, the plan information acquisition part 13 displays a predetermined input screen (to be described later) and receives, from the user, registration of the data file saved by the editing application.

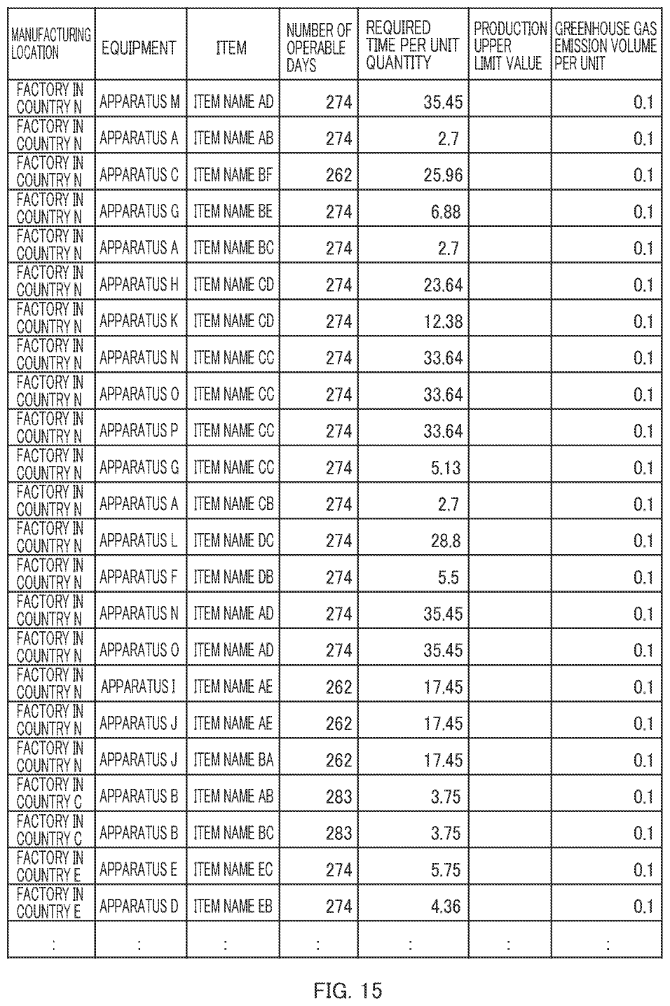

FIG. 15 is a diagram showing an example of the manufacturing capacity master table 210 registered. In this example, each manufacturing location is provided with a different number of pieces of manufacturing equipment or different types of manufacturing equipment. Also, some of the manufacturing equipment pieces can manufacture more than one type of product. Also, some of the same products can be manufactured using different pieces of manufacturing equipment.

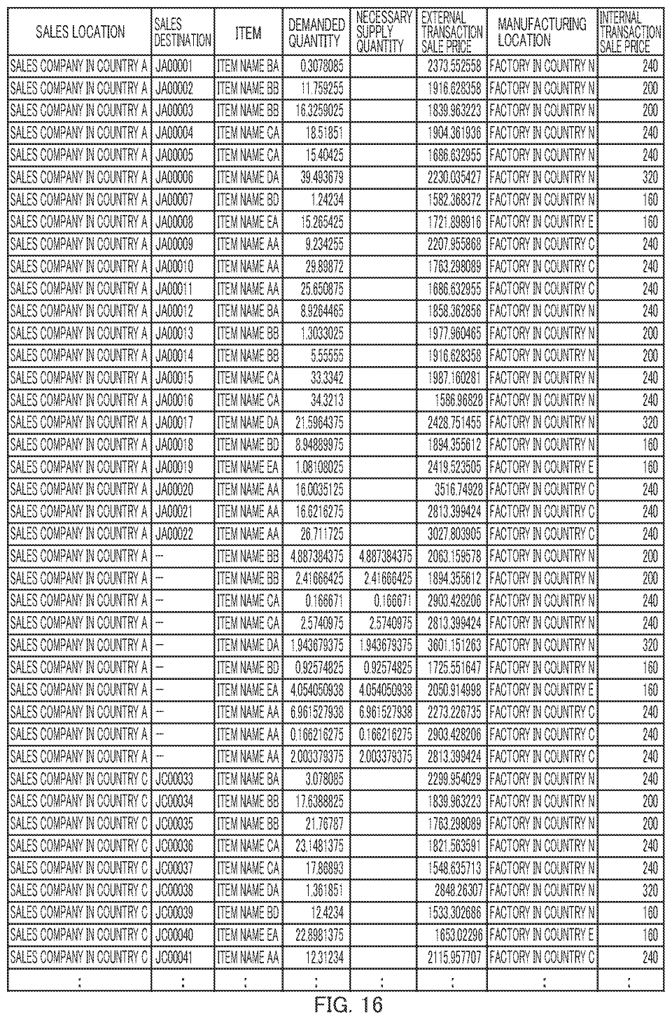

FIG. 16 is a diagram showing an example of the sales plan master table 410 registered. In this example, sales planning is carried out for a plurality of products for a plurality of sales locations, and a necessary supply quantity is set for some of the products. Also, a plurality of manufacturing locations are set for some of the products.

### (Input Screen)

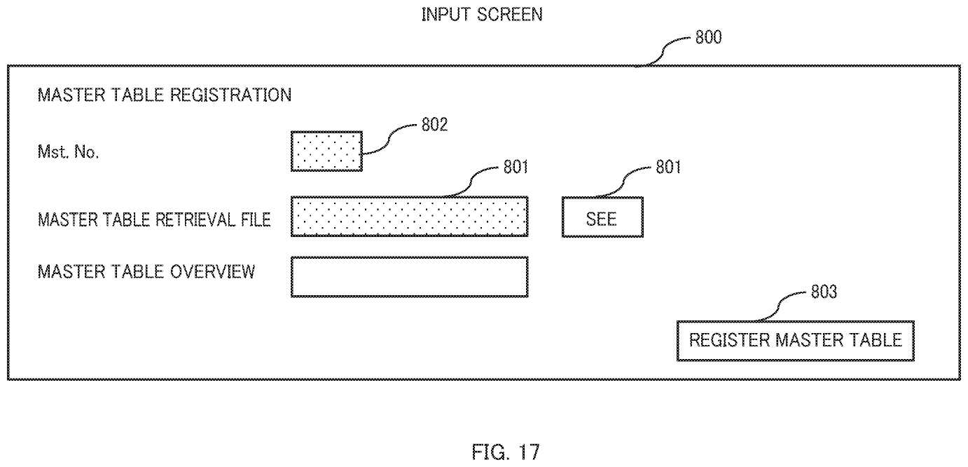

FIG. 17 is a diagram showing an example of an input screen. This input screen 800 has a file retrieval field 801 for receiving designation of a data file of a master table, a master table number registration field 802 for receiving designation of the data number of a master table, and a registration field 803 for confirming registration of the master table (data file) designated in the file retrieval field 801.

Next, as shown in FIG. 14, the manufacturing and sales planning support apparatus 10 executes simulation execution processing in which the manufacturing and sales planning support apparatus 10 creates the profit maximizing model 5 based on the master tables registered in s11 to s15 and obtains output values by executing the profit maximizing model 5 (s17). Details of the simulation execution processing will be described later.

Note that the output values are, as will be described later, for example, sales and the amount of profit of each product for each sales location (and each manufacturing location) as well as a greenhouse gas emission volume in each country, and the like. When there may be a plurality of patterns (supply chain patterns) of the processes of procurement, manufacturing, and sales of a product, the profit maximizing model 5 is executed on each of the supply chain patterns, and only output values for the supply chain pattern with the highest amount of profit are outputted. These output values are outputted to a simulation result DB 510. Results of the execution of the profit maximizing model 5 are also displayed on a simulation execution screen to be described next.

### (Simulation Execution Screen)

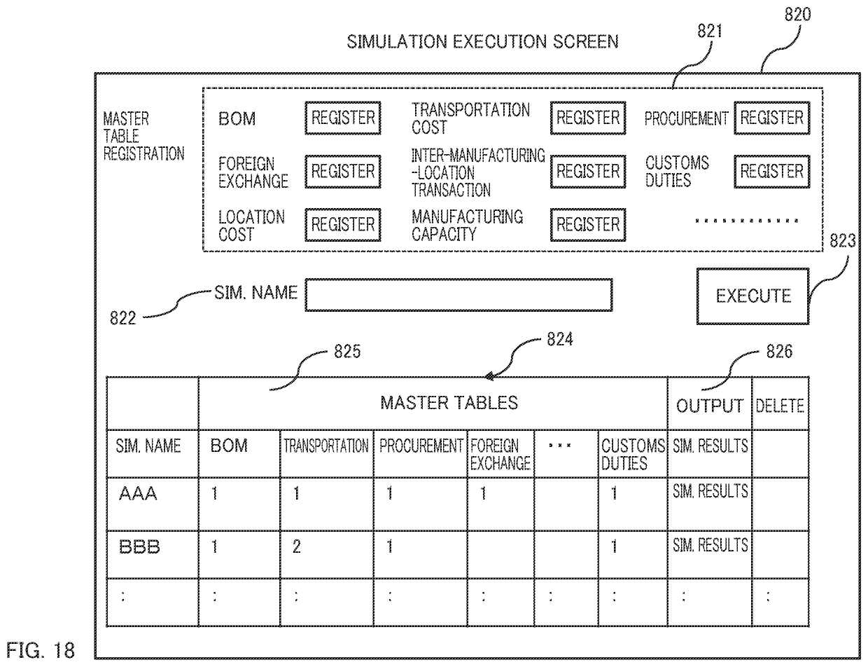

FIG. 18 is a diagram showing an example of a simulation execution screen. A simulation execution screen 820 includes a master table display field 821 for receiving registration of master tables and displaying the data numbers of the master tables registered, a name setting field 822 for setting the name of execution of the profit maximizing model 5 based on the master tables displayed in the master table display field 821, an execution start field 823 for starting execution of the profit maximizing model 5, and an execution result field 824 for displaying information on execution results.

In the master table display field 821 displaying information on the master tables (data numbers of the master tables) used for the profit maximizing model 5, the user can check the contents of product manufacturing and sales processes with maximized profit.

The execution result field 824 has, e.g., a master table list 825 displaying a list of the data numbers of the master tables registered for each execution and a result display field 826 for displaying information on the results of each execution. When the user selects the result display field 826, the contents of the execution of the model (e.g., the contents of the simulation result DB 610) are displayed.

Next, as shown in FIG. 14, the supply chain pattern creation part 17 compares the greenhouse gas emission volume in each country outputted in s17 with the upper limit value of the greenhouse gas emission volume in that country set in the greenhouse gas emission volume upper limit master table 510 (s19).

If there is a country such that the greenhouse gas emission volume outputted by the profit maximizing model 5 exceeds the upper limit of the greenhouse gas emission volume set in the greenhouse gas emission volume upper limit master table 510 (s19: YES), the supply chain pattern creation part 17 executes processing of s21. If there is no country such that the outputted greenhouse gas emission volume exceeds the upper limit of the greenhouse gas emission volume set in the greenhouse gas emission volume upper limit master table 510 (s19: NO), the supply chain pattern creation part 17 stores the output values in S17 as result information and executes processing of s25.

In s21, the simulation execution part 19 receives registration of the upper limit of the greenhouse gas emission volume reset by the user. For example, the simulation execution part 19 activates a predetermined editing application in response to an activation instruction from the user. The editing application receives user input of the upper limit of the greenhouse gas emission volume in the greenhouse gas emission volume upper limit master table 510.

Then, based on the upper limit value of the greenhouse gas emission volume set in s21, the simulation execution part 19 executes, as in s17, the simulation execution processing to execute the profit maximizing model 5 (s23).

In s25, the supply chain pattern creation part 17 displays output values outputted ultimately by the simulation execution processing on a predetermined result display screen. Based on the contents displayed on this result display screen, the user carries out business tasks related to manufacturing, sales, and the like of the product. The manufacturing and sales planning support processing thus ends.

Next, details of the simulation execution processing are described.

### <Simulation Execution Processing>

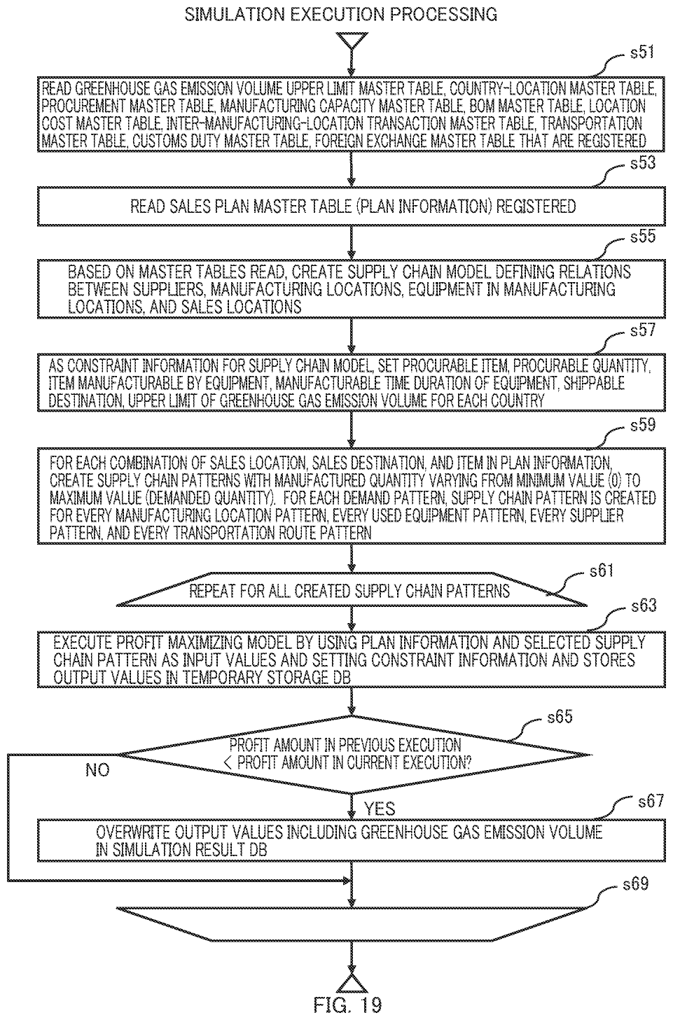

FIG. 19 is a flowchart illustrating details of the simulation execution processing.

The supply chain model creation part 15 reads each of the master tables registered in s13 and s15 (s51 and s53).

Based on the data read in s51 and s53, the supply chain model creation part 15 creates, for each product, internode relation information (a supply chain model) having nodes and links, the nodes being a supplier of a material, a manufacturing location for a material (an intermediate node) or the product, equipment in the manufacturing location, and a sales location for the product, the links being information on connections (means of transportation) between these nodes (s55).

For example, the supply chain model creation part 15 generates a supply chain model by identifying the flow of a series of processes related to procurement of a material, manufacturing of a material (an intermediate product) or a product, and sales of the product, based on the country-location master table 520, the manufacturing location 112 and the supplier 113 in the procurement master table 110, and the manufacturing location 211 and the equipment name 212 in the manufacturing capacity master table 210.

Then, the supply chain model creation part 15 creates information on the following product-manufacturing-related constraints (e.g., constraints related to a supply chain model) as constraint information: a procurable item, a procurable quantity, an item manufacturable by equipment, a manufacturable time duration of the equipment, the upper limit value of manufacturing by equipment, a shippable destination, and the upper limit of a greenhouse gas emission volume for each country (s57).

For example, the supply chain model creation part 15 creates the constraint information based on the information on the following records: the procured item 111 in the procurement master table 110 as the procurable item, the suppliable quantity 115 in the procurement master table 110 as the procurable quantity, the manufactured item 213 in the manufacturing capacity master table 210 as the item manufacturable by equipment, the number of operable days 214 and the required time 215 in the manufacturing capacity master table 210 as the manufacturable time duration of the equipment, the manufacturing upper limit value 216 in the manufacturing capacity master table 210 as the upper limit of manufacturing by equipment, the ship-from location 312 and the ship-to location 313 in the inter-manufacturing-location transaction master table 310 as the shippable destination, and the upper limit value of greenhouse gas emission volume 512 in the greenhouse gas emission volume upper limit master table 510 as the upper limit of a greenhouse gas emission volume for each country.

Note that the upper limit of a greenhouse gas emission volume for each country is the upper limit value (for each country (or region)) of the volume of greenhouse gas emissions produced by the series of processes related to manufacturing, transportation, and the like of a product. For example, a certain country requires that a total amount value ((1)+(2)+(3)) of (1) the volume of greenhouse gas emissions produced by manufacturing of a material at a supplier, (2) the volume of greenhouse gas emissions produced by manufacturing of a product (corresponding to, e.g., the volume of greenhouse gases produced at the time of manufacturing a product or the amount of electricity used to move the equipment), and (3) the volume of greenhouse gas emissions produced by transportation of the product or the material (the volume of greenhouse gases produced at the time of transportation) be no more than the upper limit value of the greenhouse gas emission volume.

Next, the supply chain pattern creation part 17 creates supply chain patterns (s59).

Specifically, the supply chain pattern creation part 17 creates combinations of the item 411, the sales location 412, and the sales destination 413 in the plan information read in s53, and for each of the combinations, creates all patterns of a supplier, a manufacturing location, manufacturing equipment, a transportation route, and means of transportation, with the demanded quantity (manufactured quantity or sales quantity) varying from 0 (minimum value) to the value of the demanded quantity 414 (maximum value) read in s13.

More specifically, the supply chain pattern creation part 17 refers to the supply chain model, the manufacturing capacity master table 210, and the like and, in a case where a product or intermediate product of the same item can be manufactured at different manufacturing locations or by different pieces of manufacturing equipment, creates a supply chain pattern for each of cases of using those manufacturing locations and pieces of manufacturing equipment. Note that in this case, only a portion of the set manufactured quantity may be allocated to other manufacturing locations or pieces of manufacturing equipment.

Also, the supply chain pattern creation part 17 refers to the supply chain model, the procurement master table 110, and the like and, in a case where a material of the same item can be procured from a plurality of different suppliers, creates a supply chain pattern for each of the cases of procuring the material from those suppliers. Note that in this case, only a portion of the set procured quantity may be allocated to other suppliers.

Also, the supply chain pattern creation part 17 refers to the supply chain model, the transportation master table 320, and the like and, in a case where a material or product can be transported using a plurality of different transportation routes (transportation routes from a supplier to a manufacturing location to a sales destination) or means of transportation, creates a supply chain pattern for each of the cases of using those transportation routes and means of transportation. Note that in this case, only a portion of the set manufactured quantity may be allocated to other transportation routes or means of transportation.

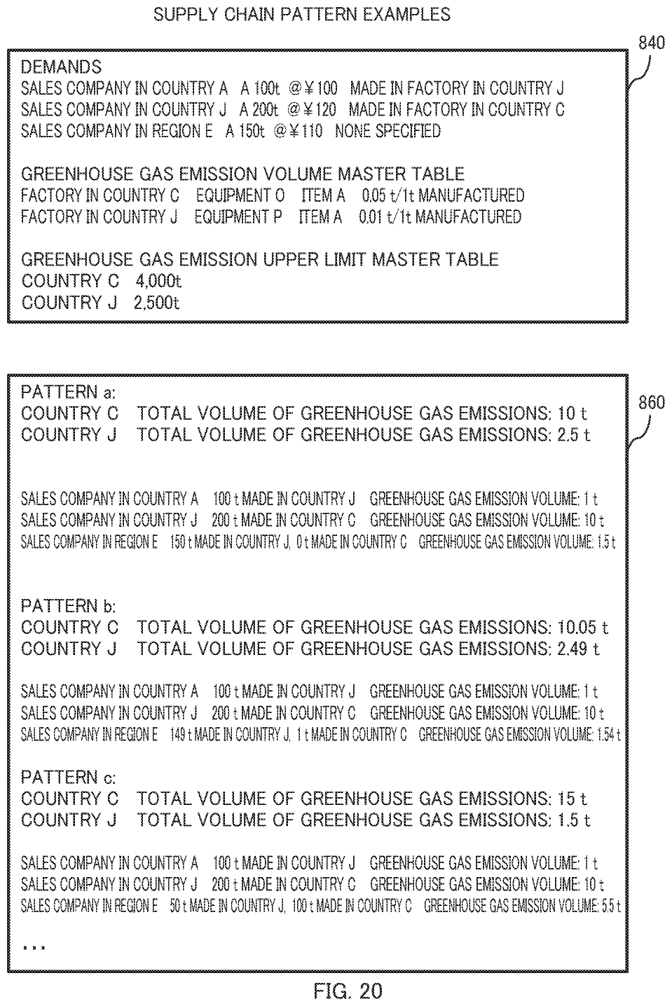

FIG. 20 is a diagram illustrating an example supply chain pattern. As shown in FIG. 20, in a case (reference numeral 840) where sales destinations of an item A are country A, country J, and region E which demand quantities of 100 t, 200 t, and 150 t, respectively, and where there are no constraints on a manufacturing location when region E is a sales destination, a supply chain pattern 860 corresponding to this case includes the following patterns: a “pattern a” in which a manufacturing location when a sales destination is region E is only country J (that demands a quantity of 150 t), a “pattern b” in which manufacturing locations when a sales destination is region E are country J and country C (that demand quantities of 149 t and 1 t, respectively), and a “pattern c” in which manufacturing locations when a sales destination is region E are country J and country C (that demand quantities of 50 t and 150 t, respectively). Note that for each of the supply chain patterns, the volume of greenhouse gas emissions related to manufacturing of the product is calculated for each selling country, and the volume of greenhouse gas emissions in each emission country is calculated.

Next, as shown in s61 in FIG. 19, the simulation execution part 19 creates the profit maximizing model 5 in which the supply chain model created in s55 and the constraint information (constraint conditions) created in s57 are set. Then, the simulation execution part 19 selects one of the supply chain patterns created in s59 and executes the profit maximizing model 5 by inputting the selected supply chain pattern to the created profit maximizing model 5. For each supply chain pattern, the profit maximizing model 5 outputs the following pieces of information: the sales quantity of the product, the sales profit of the product, a total volume of greenhouse gas emissions produced by manufacturing of the product, manufacturing equipment used to manufacture the product, a supplier of a material needed to manufacture the product, the procured quantity of the material needed to manufacture the product, and means of transportation of the product or material.

The profit maximizing model 5 is, in the present embodiment, a model based on linear programming. For example, the profit maximizing model 5 is an objective function that includes, as its constituents, functions representing the supply chain model, functions representing constraint conditions, and functions representing input values, and calculates the amount of profit gained by manufacturing and sales of the product. The simulation execution part 19 also outputs the values of variables with which the amount of profit, which is the value of the objective function, is maximum. In other words, the profit maximizing model 5, when calculating and outputting the maximum amount of profit, outputs information obtained or used in the process of the calculation (for example, a sales amount, manufacturing equipment used, a supplier of a material, the quantity of the material procured, means of transportation, the greenhouse gas emission volume and the like).

Note that the profit maximizing model 5, in the process of the calculation, calculates the sales amount of a product by multiplying the sales quantity of the product by its selling price. Also, the profit maximizing model 5 calculates the profit of each product in each country by deducting costs (e.g., the amount of customs duties calculated based on the internal transaction unit price, the purchase price of the material, variable and fixed costs at the manufacturing location, and transportation costs) from the sales amount and performing conversion in the calculation of the sales and the costs using the foreign exchange rates of the countries. Also, the profit maximizing model 5 calculates a total volume of greenhouse gas emissions for each product by finding the sum of the volume of greenhouse gas emissions produced by procurement of its material, the volume of greenhouse gas emissions produced by manufacturing of the material or product, and the volume of greenhouse gas emissions produced by management and maintenance at a manufacturing location (allocated greenhouse gas emission volume).

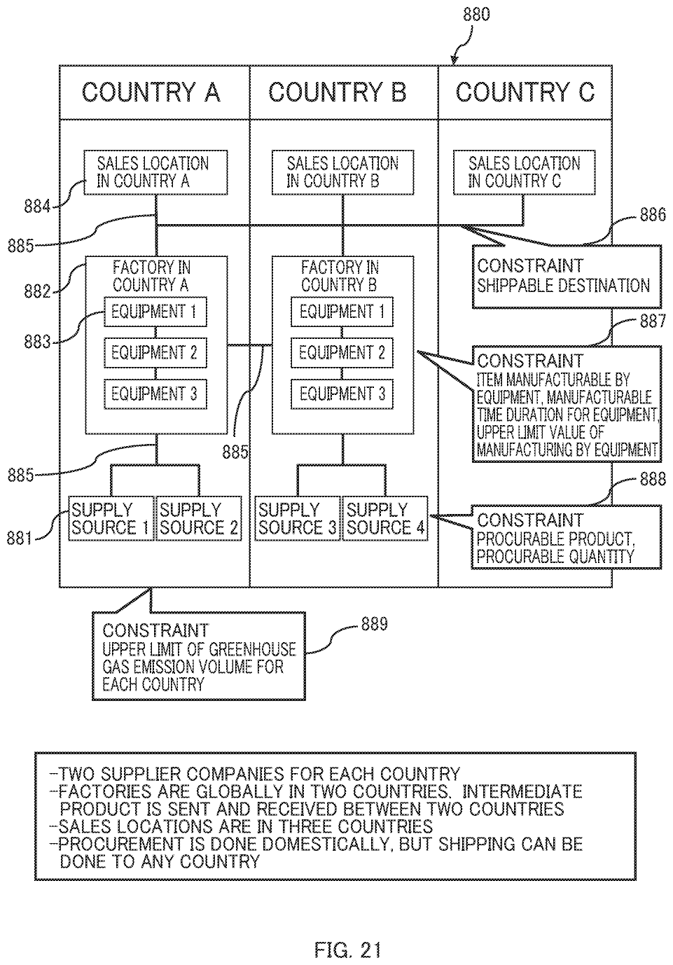

FIG. 21 is a diagram illustrating an example configuration of a supply chain model. This supply chain model 880 stores, as nodes, a supply source 881 (supplier) of a material, a manufacturing location 882 (a factory at a certain location in a certain country) where the material is used to manufacture another material or a product, manufacturing equipment 883 installed at the manufacturing location 882, and a sales location 884 (country) to which the product is shipped from the manufacturing location 882. The supply chain model 880 also stores, as links, transportation routes 885 between the supply source 881, the manufacturing location 882, and the sales location 884.

The supply chain model 880 also has constraint information 886 related to the sales location 884 (shippable destination), constraint information 887 related to the manufacturing location 882 (an item manufacturable by equipment, a manufacturable time duration for equipment, and the upper limit value of manufacturing by equipment), and constraint information 888 related to a relation between the supply source 881 and the manufacturing location 882 (a procurable product, a procurable quantity).

The supply chain model 880 also has constraint information 889 related to the volume of greenhouse gas emissions produced by a series of processes including transportation between the supply source 881 and the manufacturing location 882, between the manufacturing locations 882, and between the manufacturing location 882 and the sales location 884 as well as management, maintenance, and manufacturing at the manufacturing location 882 (the upper limit of the greenhouse gas emission volume for each country (or region)).

Next, as shown in FIG. 19, the simulation execution part 19 selects one of the supply chain patterns created in s59 (s61), obtains output values by inputting the selected supply chain pattern into the profit maximizing model 5, and stores the obtained output values in a temporary storage DB (s63). Note that the simulation execution part 19 performs processing of s69 to be described later if the output values obtained do not meet the constraint conditions.

The simulation execution part 19 compares the amount of profit that has just been outputted in s63 and the amount of profit that has previously been calculated in s63 (0 when s65 is performed for the first time) (s65). If the amount of profit that has just been outputted is larger than the amount of profit previously calculated (s65: YES), the simulation execution part 19 sets the amount of profit that has just been outputted to the maximum profit amount, stores it in the simulation result DB 610 (s67), and then performs processing of s69. Meanwhile, if the amount of profit that has just been outputted is equal to or smaller than the amount of profit previously calculated (s65: NO), the simulation execution part 19 performs the processing of s69.

In s69, the simulation execution part 19 checks whether there is another supply chain pattern, and if there is another supply chain pattern, repeats the processing in and after s61 for that supply chain pattern. If there is no other supply chain pattern, the simulation execution part 19 ends the simulation execution processing.

### (Simulation Result DB)

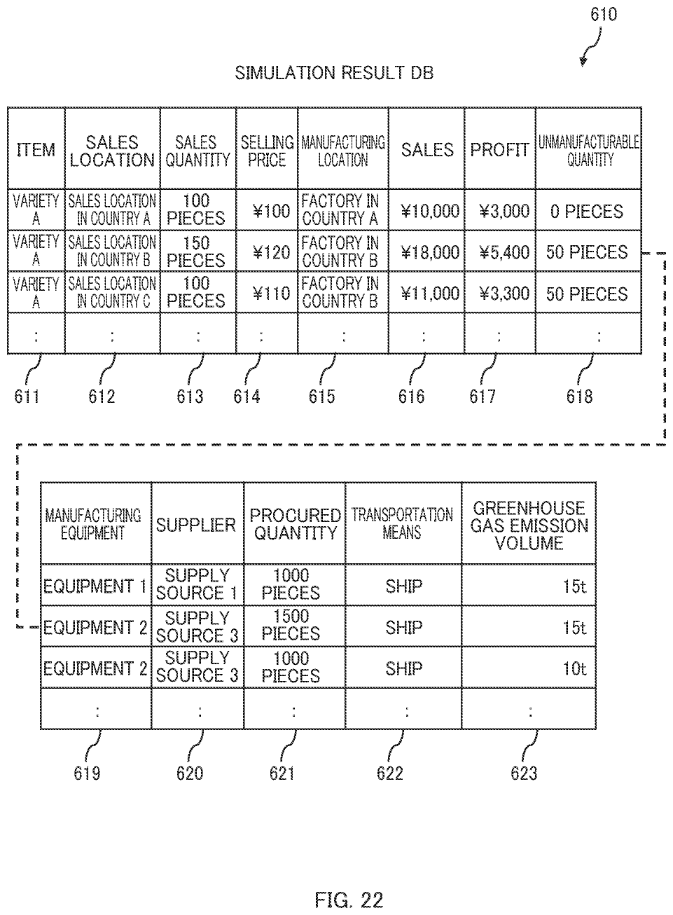

FIG. 22 is a diagram showing an example of the simulation result DB 610. The simulation result DB 610 has the following data items: item 611 to set information on the item as a product to be manufactured, sales location 612 to set information on a sales location for the product, sales quantity 613 to set the quantity of the product sold at the sales location, selling price 614 to set the selling price of the product, manufacturing location 615 to set information on a manufacturing location where the product sold at the sales location is manufactured, sales 616 to set information on the amount of sales of the product, profit 617 to set the amount of profit based on the sales of the product, unmanufacturable quantity 618 to set information of the quantity of the product that could not be manufactured relative to the quantity demanded at the sales location, manufacturing equipment 619 to set information on manufacturing equipment used to manufacture the product manufactured at the manufacturing location, supplier 620 to set information on a supplier of a material for the product manufactured at the manufacturing location, procured quantity 621 to set the quantity of the material procured, transportation means 622 to set information on means of transportation of the material, and greenhouse gas emission volume 623 to set a sum total volume of greenhouse gas emissions produced by a series of processes in manufacturing of the product sold at the sales location.

As described above, the manufacturing and sales planning support apparatus 10 of the present embodiment inputs, to the profit maximizing model 5, information on a sales destination of a product and the quantity of the product demanded at the sales destination (plan information) and a plurality of supply chain patterns which are information including patterns of processes of manufacturing and sales of the product manufactured in a quantity corresponding to the demanded quantity, thereby calculating the maximum profit gained based on each of the supply chain patterns with greenhouse gas emissions being at or below a predetermined upper limit and calculating the volume of greenhouse gases emitted by each of the processes.

In other words, based on the patterns of manufacturing and sales of a product in a quantity as demanded at the sales destination, the manufacturing and sales planning support apparatus 10 of the present embodiment can calculate the maximum profit gained without the greenhouse gas emission volume exceeding the predetermined upper limit.

In this way, the manufacturing and sales planning support apparatus 10 of the present embodiment can support manufacturing and sales planning that can comply with restrictions on the greenhouse gas emission volume.

Further, the manufacturing and sales planning support apparatus 10 according to the present embodiment creates a plurality of patterns of the manufactured quantity which is equal to or below the demanded quantity, and by input of each of the supply chain patterns related to the created patterns of the manufactured quantity to the profit maximizing model 5, the maximum profit and the volume of greenhouse gases emitted are calculated.

Thus, the maximum profit can be calculated for a scenario where a product is manufactured in any quantity within a limit that can comply with the upper limit value of the greenhouse gas emission volume.

The manufacturing and sales planning support apparatus 10 according to the present embodiment creates, as the supply chain patterns, a plurality of patterns of a manufacturing location for the product or manufacturing equipment for the product at the manufacturing location.

Thus, in a case where a product can be manufactured at any one of a plurality of manufacturing locations or by any one of pieces of manufacturing equipment, the maximum profit gained without the greenhouse gas emission volume exceeding a predetermined upper limit can be calculated with those taken into consideration.

The manufacturing and sales planning support apparatus 10 according to the present embodiment creates, as the supply chain patterns, a plurality of patterns of a supplier of a material needed to manufacture the product.

Thus, in a case where there are a plurality of supplier options for a material, the maximum profit gained without the greenhouse gas emission volume exceeding a predetermined upper limit can be calculated with those taken into consideration.

The manufacturing and sales planning support apparatus 10 according to the present embodiment creates, as the supply chain patterns, a plurality of patterns of a route of transportation or means of transportation of the product or a material needed to manufacture the product.

Thus, in a case where there are a plurality of routes of transportation or means of transportation, the maximum profit gained without the greenhouse gas emission volume exceeding a predetermined upper limit can be calculated with those taken into consideration.

The manufacturing and sales planning support apparatus 10 according to the present embodiment is configured to display information on the maximum profit calculated by the profit maximizing model 5 and display information on the processes for the manufacturing and sales of the product, the processes being inputted to the profit maximizing model 5.

Thus, a user can know the specific contents of a manufacturing and sales plan that can comply with restrictions on the greenhouse gas emission volume.

The above description of the embodiment has been provided not to limit the present invention thereto but to facilitate understanding of the present invention. The present invention can be modified or improved without departing from the gist thereof and includes such equivalents as well.

For example, the configuration of each functional part of the manufacturing and sales planning support apparatus 10 is an example. For example, a certain functional part may be provided to a different functional part, or a plurality of functional parts may be integrated into a single functional part. Also, some of the functional parts of the manufacturing and sales planning support apparatus 10 may be provided in another communicable information processing apparatus.

In addition, the data items of each master table described in the present embodiment are an example. A different item may be added, or some items may be omitted.

In addition, although set for every country in the present embodiment, the upper limit of a greenhouse gas emission volume may be set for another unit (e.g., a location, a supplier, or a manufacturer).

What is claimed is:

1. A manufacturing and sales planning support apparatus comprising:
a processor;
a memory;
a numerical model storage part configured to store a numerical model that receives, as input values, a sales destination of a product whose manufacturing and sales involves greenhouse gas emission, a demanded quantity of the product at the sales destination, and processes for the manufacturing and sales of the product, and calculates, as output values, a maximum profit gained based on the processes with the greenhouse gas emission being at or below a predetermined upper limit and a volume of greenhouse gases emitted by the processes;
a plan information acquisition part configured to acquire information related to the sales destination of the product and the demanded quantity of the product at the sales destination;
a supply chain pattern creation part configured to create a plurality of supply chain patterns each being information including a pattern of the processes for the manufacturing and sales of the product manufactured in a manufactured quantity corresponding to the demanded quantity; and
a simulation execution part configured to input each of the created supply chain patterns into the numerical model along with the acquired sales destination and the manufactured quantity and thereby calculate a maximum profit gained based on each of the supply chain patterns with the greenhouse gas emission being at or below the predetermined upper limit and a volume of greenhouse gases emitted by the processes.

2. The manufacturing and sales planning support apparatus according to claim 1, wherein
the supply chain pattern creation part creates a plurality of patterns of the manufactured quantity which is equal to or below the acquired demanded quantity, and
by input of each of the supply chain patterns related to the created patterns of the manufactured quantity to the numerical model, the maximum profit and the volume of greenhouse gases emitted are calculated.

3. The manufacturing and sales planning support apparatus according to claim 1, wherein
the supply chain pattern creation part creates, as the supply chain patterns, a plurality of patterns of a manufacturing location for the product or manufacturing equipment for the product at the manufacturing location.

4. The manufacturing and sales planning support apparatus according to claim 1, wherein
the supply chain pattern creation part creates, as the supply chain patterns, a plurality of patterns of a supplier of a material needed to manufacture the product.

5. The manufacturing and sales planning support apparatus according to claim 1, wherein
the supply chain pattern creation part creates, as the supply chain patterns, a plurality of patterns of a route of transportation or means of transportation of the product or a material needed to manufacture the product.

6. The manufacturing and sales planning support apparatus according to claim 1, further comprising a result display part configured to display information on the maximum profit calculated by the numerical model and display information on the processes for the manufacturing and sales of the product, the processes being inputted to the numerical model.

7. A manufacturing and sales planning support method implemented by an information processing apparatus, comprising executing:
numerical model storage processing to store a numerical model that receives, as input values, a sales destination of a product whose manufacturing and sales involves greenhouse gas emission, a demanded quantity of the product at the sales destination, and processes for the manufacturing and sales of the product, and calculates, as output values, a maximum profit gained based on the processes with the greenhouse gas emission being at or below a predetermined upper limit and a volume of greenhouse gases emitted by the processes;
plan information acquisition processing to acquire information related to the sales destination of the product and the demanded quantity of the product at the sales destination;
supply chain pattern creation processing to create a plurality of supply chain patterns each being information including a pattern of the processes for the manufacturing and sales of the product manufactured in a manufactured quantity corresponding to the demanded quantity; and
simulation execution processing to input each of the created supply chain patterns into the numerical model along with the acquired sales destination and the manufactured quantity and thereby calculate a maximum profit gained based on each of the supply chain patterns with the greenhouse gas emission being at or below the predetermined upper limit and a volume of greenhouse gases emitted by the processes.

8. The manufacturing and sales planning support method according to claim 7, wherein
in the supply chain pattern creation processing, the information processing apparatus creates a plurality of patterns of the manufactured quantity which is equal to or below the acquired demanded quantity, and
by input of each of the supply chain patterns related to the created patterns of the manufactured quantity to the numerical model, the maximum profit and the volume of greenhouse gases emitted are calculated.

9. The manufacturing and sales planning support method according to claim 7, wherein
in the supply chain pattern creation processing, the information processing apparatus creates, as the supply chain patterns, a plurality of patterns of a manufacturing location for the product or manufacturing equipment for the product at the manufacturing location.

10. The manufacturing and sales planning support method according to claim 7, wherein
in the supply chain pattern creation processing, the information processing apparatus creates, as the supply chain patterns, a plurality of patterns of a supplier of a material needed to manufacture the product.

11. The manufacturing and sales planning support method according to claim 7, wherein
in the supply chain pattern creation processing, the information processing apparatus creates, as the supply chain patterns, a plurality of patterns of a route of transportation or means of transportation of the product or a material needed to manufacture the product.

12. The manufacturing and sales planning support method according to claim 7, further comprising executing result display processing, by the information processing apparatus, to display information on the maximum profit calculated by the numerical model and display information on the processes for the manufacturing and sales of the product, the processes being inputted to the numerical model.
